(19) United States
(12) Patent Application Publication
(10) Pub. No.: US 2008/0036894 A1
(43) Pub. Date: Feb. 14, 2008

(54) Comparison apparatus and method for obtaining photographic effects

(76) Inventor: Mohammed Alsaud, Beverly Hills, CA (US)

Correspondence Address: Klaus P. Stoffel;Wolff & Samson PC, One Boland Drive, West Orange, NJ, 07058, US

(21) Appl. No.: 11/502,710

(22) Filed: Aug. 10, 2006

(51) Int. Cl. H04N 5/222

(52) U.S. Cl. 348/333.01

(57) ABSTRACT

A comparison apparatus and method for obtaining photographic effects is provided. The apparatus includes a digital display screen, and a digital memory containing multiple example images and diagrams to show how those example images were achieved. The images in the memory are classified by lighting type, color, camera, and lens. Images in the memory are displayed along with a list showing the settings used when the example images were acquired. The digital memory contains images obtained by a comprehensive study of light and color with varying attributes of the photographic process. The method includes the steps of choosing a digital memory for the type of lighting the photographer will use, whether ambient, artificial or both, inserting the memory into a digital display screen, displaying a number of example digital photographs from the memory, choosing the photograph from the memory that has the look selected by the user, and displaying a diagram and other relevant information of the setup for the photograph.

### BACKGROUND OF THE INVENTION

1. Field of the Invention

The present invention relates to an image comparison system containing detailed and elaborate information relevant to essential variables such as cameras and lenses, environment diagrams, aperture and shutter speeds, laboratory processing, digital card or film type and many other image determinants.

2. Related Background Art

The aspect of photography that drains the most time, money, and energy on the part of the professional photographer is not the actual content of the image, but rather the lack of certainty surrounding the use and combination of light, camera settings, digital card or film, digital or film processing, filter, reflex, and ambient situations. Minor variations in each of these aspects of the photograph's environment can lead to drastic, and often surprising, changes in the final image.

What many photographers do, even those with years of experience, is take many pictures with related parameters, with the expectation that a few of the images will have the characteristics they are looking for, while the vast majority of the images will be thrown away. With limited time, money, and resources, they often repeat themselves in lighting, camera settings, and ambient situations. Alternatively, they could conduct extensive and costly prohibitive testing. More likely, many, if not most, photographers would concentrate on utilizing a few methods and would refrain from exploring new territory of lighting, color, and precision of expected and desired result. Many, indeed, would find the entire process of photography frustrating, dazzling in unknown details, and draining in energy and resources.

Thus, a need exists for an apparatus and method for providing photographers with a consistent and reliable standard against which precise and targeted photographic effects can be achieved. The apparatus and method should assist the user in the selection of photographic attributes. Such an apparatus and method should also help the photographer take images having precise and targeted photographic effects. The new invention provides an innovative and novel solution to the above needs.

### SUMMARY OF THE INVENTION

A comparison apparatus and method for obtaining photographic effects is provided. The apparatus includes a digital display screen, and a digital memory containing multiple example images and diagrams to show how those example images were achieved. The images in the memory are classified by lighting type, color, camera, and lens. The images in the memory are displayed along with a list showing the settings used when the example images were acquired. The digital memory contains images obtained by a comprehensive study of light and color with varying attributes of the photographic process. The method includes the steps of choosing a digital memory for the type of lighting the photographer will use, whether ambient, artificial or both, inserting the memory into a digital display screen, displaying a number of example digital photographs from the memory, choosing the photograph from the memory that has the look selected by the user, and displaying a diagram together with other relevant information of the setup for the photograph.

### BRIEF DESCRIPTION OF THE DRAWINGS

FIG. 1 shows a view of the present invention.

FIG. 2 shows a detailed view of the present invention.

FIG. 3 shows a view of the images display screen.

FIGS. 4a and 4b show views of the 1-10 and 11-end images display screen.

FIG. 5 shows a view of the 20 images display screen.

FIG. 6 shows a view of the 1-10 images with diagram display screen.

FIG. 7 shows a view of the 11-end images with diagram display screen.

FIG. 8 shows a view of one image with a diagram display screen.

FIG. 9 shows a view of a diagram with relevant information display screen.

FIG. 10 shows a view of chosen exhibited and stored images with the single image display screen.

### DETAILED DESCRIPTION OF THE INVENTION

### Purpose

The invention is called the Pro-standard Screen. The Pro-Standard Screen can be embodied as a self-contained computing device, as described in the associated details and drawings, or embodied as an equivalent set of features on a conventional computing device or medium, such as a Pro-Standard Card, a smart card, an electronic chip or any other equivalent medium to be manifested in the pro-Standard Screen, and called as such “the Pro-Standard Screen”.

The Pro-Standard Screen is meant to introduce the amateur and professional photographer to the various possibilities of using each light source in different settings and situations, as well as to inform the photographer about the exact methods and techniques used in order to obtain the desired color and light effects. As such, it is a time- and material-saver. This is especially so when only the very best images (about 3% of all tested methods and techniques) are ever considered. It is meant to raise the level of competence and excellence in photography by controlling to almost perfection the various elements of production, while allowing the photographer the opportunity to concentrate his time, money, and effort on issues of overall production, environment, and creativity.

Pro-Standard Screen addresses the question of choice of particular light and color effects for particular situations, while providing all the essential information about how a particular image effect can be achieved. Aside from what an image says in gesture and environmental setting, certainty of light and color effects is the most lacking in photography.

It drains the energy and resources of most professional photographers, regardless of how much experience they might have, limits their options and horizons, creates endless apprehensions of possible and likely failure to try new or other techniques, and frustrates from beginning to end the production process.

For example, much time, money and effort is spent inefficiently on digital cards, film, digital and film laboratory processing, glass filters, gels, reflexes, testing and using various lights, equipment, and gear, assistants and labor, as well as specialized digital work (one image worked on digitally for publicity or advertising could easily cost $10,000, if not more.)

Such resources used daily by the photographer could better be saved and used much more efficiently on issues of upgrading and improving the overall production, environment, and creativity involved in the making of an image, had the photographer had an efficient method of controlling his various production elements while being assured of excellence in visual quality, as far as light and color are concerned, as predetermined by the prior choice of the desired image effects by the photographer.

The most important aspect of the Pro-standard Screen is that it is expected to raise the standards of photography, in as much as light and color are concerned, whether natural light, artificial light, or a combination of both, is used, to unprecedented levels. In as much as light and color effects become predictable, it is expected to permanently alter the standards by which photography is measured by releasing the energy and resources of photographers to concentrate on issues of gesture, environment, and creativity.

### Apparatus

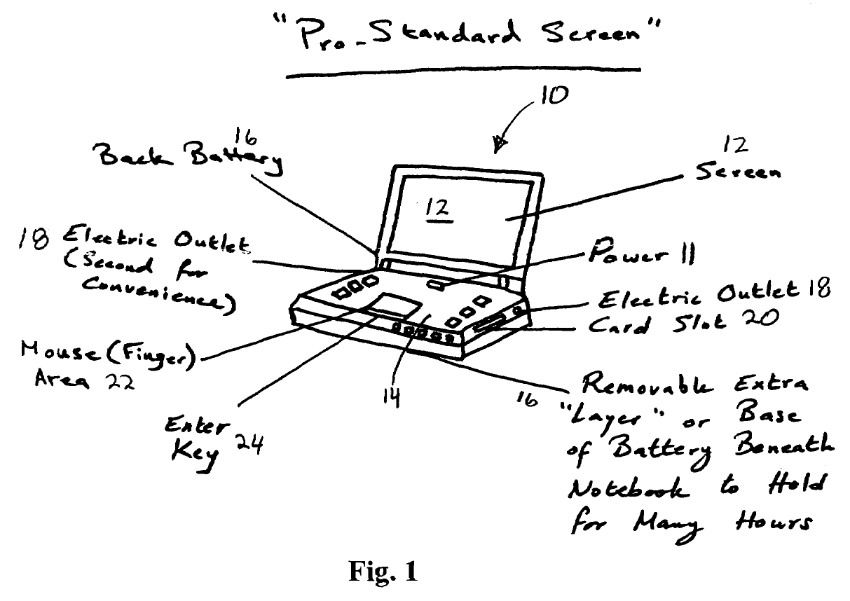

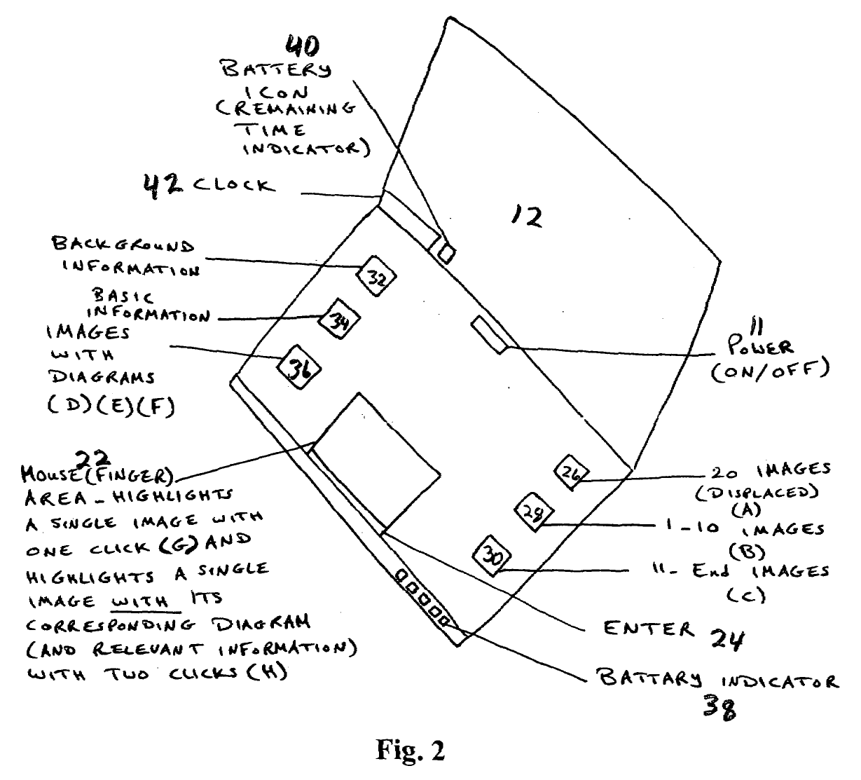

The invention as described in FIG. 1 is a digital screen device 10 composed of three parts: a screen 12, a keyboard 14, and a removable (and optional) extra layer or base of battery 16 beneath the keyboard 14 that complements the normal-size battery beneath the screen 12 and allows for many extra hours of usage without connecting to electricity, if so chosen. The digital screen device 10 is not to be connected to a network or to the Internet or anything else except possibly a power source. It has a turn on/turn off power button 11. It also has two electrical outlets 18, one on each side of the keyboard 14 through which an electric cable can be used on either side, to charge the digital screen device 10, or its batteries with electricity. The digital screen device 10 has an opening 20 on the side of the keyboard 14 that allows for a smart card (not shown), a disk, an electronic chip, or any other equivalent memory media, whether invented presently or in the future, to be placed. Also disposed on keyboard 14 is a mouse or pointer area 22 and an enter key 24. As indicated on the keyboard 14 in FIG. 2 there are disposed three buttons 26, 28 and 30. Once placed in card opening 20, the memory displays approximately twenty images. The three buttons 26, 28 and 30, give the user the option to maintain the initial display of approximately twenty images on the screen 12, once the digital screen device is turned on, using a power button 11, to display the first ten images from the memory or to display the remainder of the images.

On the keyboard 14, there are also disposed three buttons 32, 34 and 36 that can be pressed to display Background Information, Basic Information and Images with Diagrams. Whereas Background information 32 and Basic information 34 provide information relevant to the concept of the Pro-Standard Screen and the constituent elements of the image, Images with Diagrams 36 provides images with diagrams and other relevant information corresponding to each image.

On the lower right side of the keyboard 14 facing the user, there is a battery indicator 38 with a display to indicate the usable time left in the battery. To have a more accurate reading of percentage of usage and time remaining for battery use, a battery icon 40, can be highlighted with an arrow on the screen 12, next to a clock display 42 that may be highlighted to display the day, month, and year. On the lower middle side of the digital screen device the pointer area 22 is used to move a cursor on the screen 12.

### Operation

Once placed in card opening 20, the memory displays approximately twenty images 50 as shown in Screen (A). The three buttons 26, 28 and 30 give the user the option to maintain, on the Screen 12, the initial display of approximately twenty images 26, as shown in Screen (A), the option to display the first ten images 28, as shown in Screen (B), or the option to display the remainder of the images that may or may not amount to ten images 30, as shown in screen (C). When a cursor 54, as shown in Screen (A), is placed on any single image, in the images displayed in Screen (A), (B) or (C), 50 and the user clicks the Enter Key 24, the single image chosen is displayed, and when a user double clicks on that chosen image, a single image 50 is displayed along with its corresponding diagram and attributes and other relevant information 52.

### Content of Images & Diagrams

The content of the Pro-Standard Card or memory device includes a variety of subject matters, such as: portrait, editorial, advertising, people photography, wedding, journalism, street photography, product, furniture, car, outdoor and travel, landscape, architectural, sea life, underwater, nocturne, nature, wildlife, environmental, fine art, still life, and compact and limited light photography, among others.

The invention displays images having standard content, acquired using a particular combination of characteristics. These characteristics are varied in a systematic way for all the images on a Pro-Standard Card, allowing the user to identify the characteristics most likely to produce the result desired by that user. The user is provided with these characteristics in the form of a Diagram corresponding to an image with essential information relevant to the production of the image.

The Diagram includes a drawing of the actual juxtaposition of distances of the camera, the artificial light, the reflexes and screens (if existent), the subject, as well as essential information for the actual understanding and taking of the image, such as aperture and shutter speed, digital card or film type, laboratory processing, filter type, filter aperture adjustment, reflex size and type, sun reflection or screening color, size, and type (see screen sample “H” and “I”).

Basic Information is essential information relevant to the concept of the Pro-Standard Screen, apertures and shutter speeds, focus, digital and film cards, laboratory processing, glass filters, gels, lighting, reflexes, ambient reflection and screening. It also includes basic information on camera lenses, film backs, and accessories, as well as camera dealers and services. Numerous relevant and comparative images are presented, in an elaborate manner in order to thoroughly explain the parameters and results due to varying aperture, shutter speed, focus, digital cards or film, digital or film laboratory processing, glass filters, gels, lighting types and techniques, reflex types, and ambient reflection and screening, as well as various types of cameras and lenses.

Background Information is information pertaining to the constituent elements used to take the images such as more detailed information about the manufacturers, brands, and types of cameras, lenses, filters, gels, digital cards or film types, digital card, digital or film laboratory processing, reflexes, sun reflection, sun screening, or both, and other pertinent information. This background information describes the characteristics for all the images displayed on the Pro-Standard Card or its equivalent, or the characteristics of a particular image on that card.

The Pro-Standard Cards or their equivalent used in the Pro-Standard Screen are numbered and classified according to light type, whether artificial, ambient, or a combination of both, as well as color, camera and lens. As such, displayed on the upper part of each image showing on the screen is the number of the card used as well as the light type, color, camera and lens. When a single image is displayed, such as in screen samples “G,” “H,” and “I, the number of the card or its equivalent and the number of the image as well as the light type, color, camera and lens are shown.

### Using Diagrams

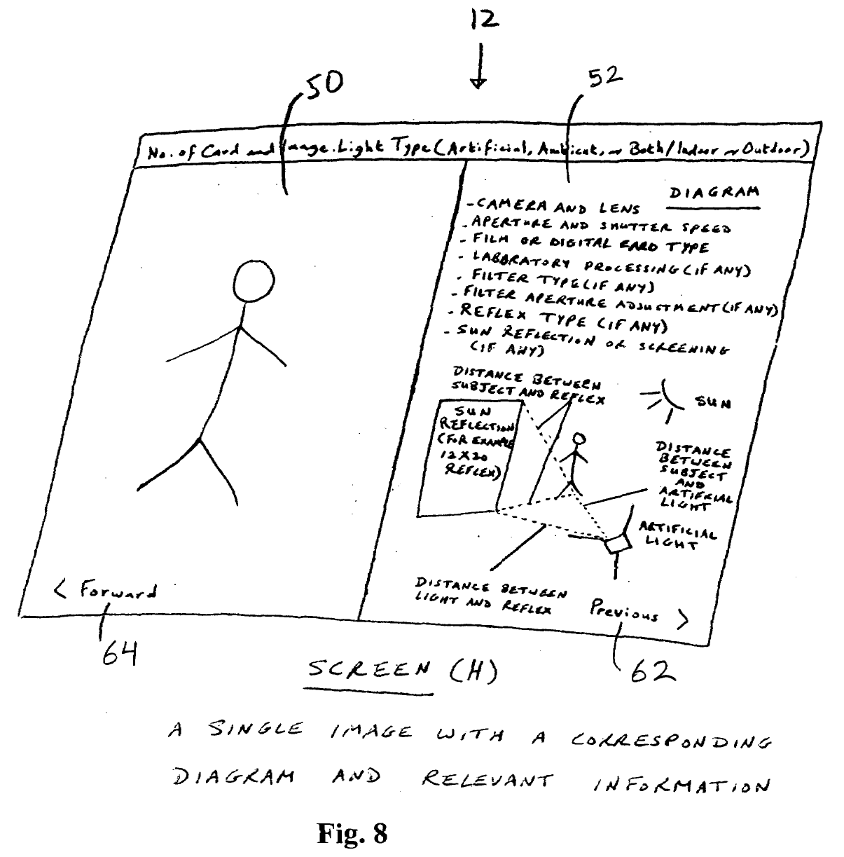

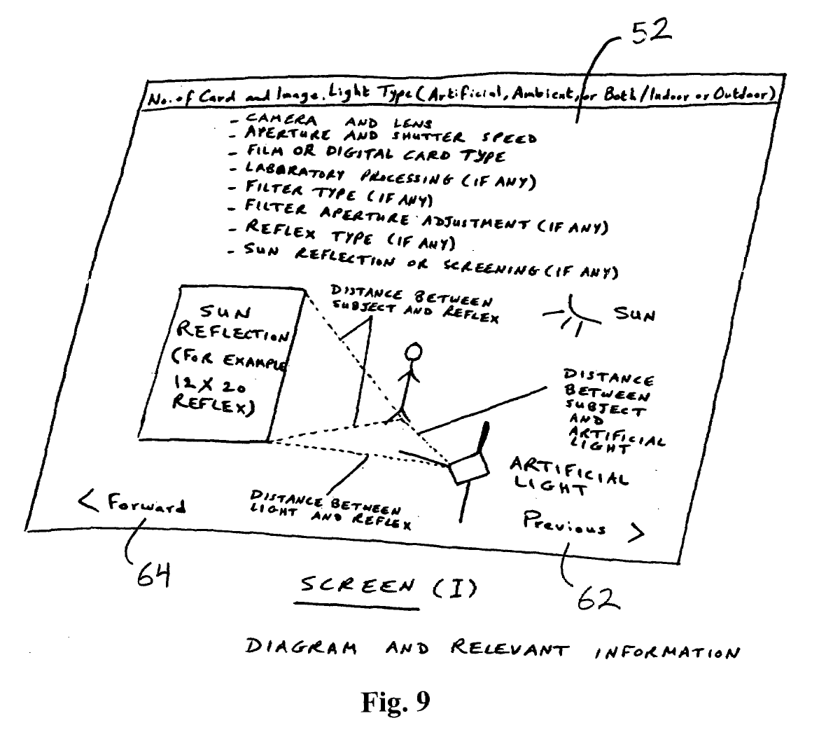

The diagram 52, as best shown in FIGS. 8 and 9 shows a diagram of the photographic setup and other relevant information and may include a diagram of the actual juxtaposition of distances of the light, the camera, the subject, the reflexes and screens, as well as essential information for the actual understanding and taking of the photographic image, such as camera and lens type, aperture and shutter speed, card or film type, laboratory processing, filter type, filter aperture adjustment, reflex size and type, sun reflection or screening color, size, and type.

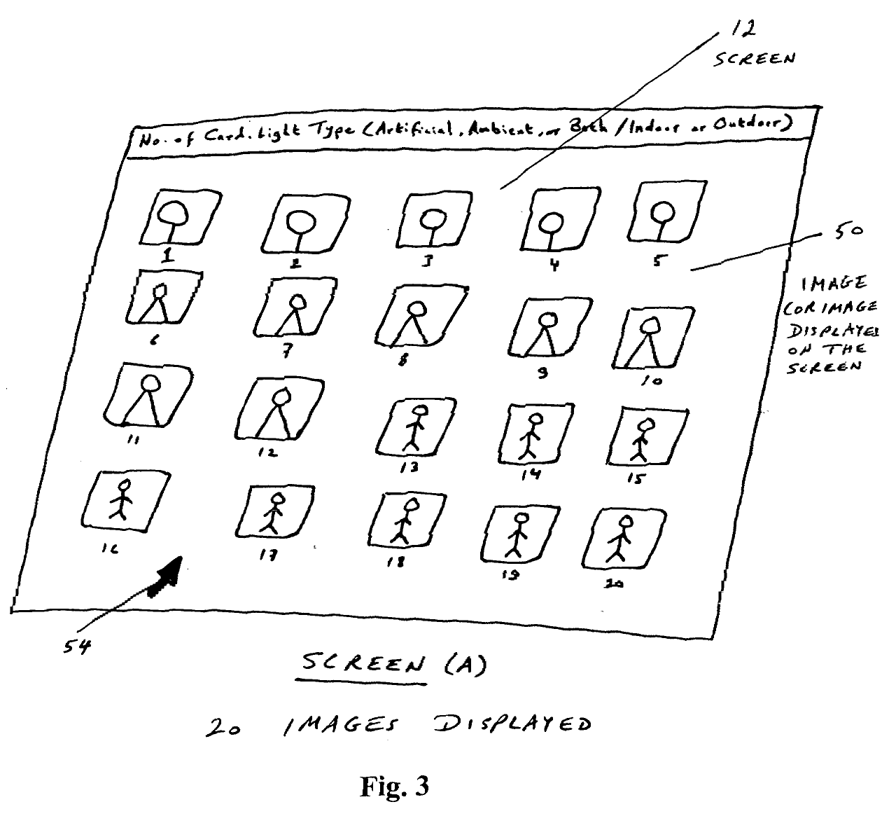

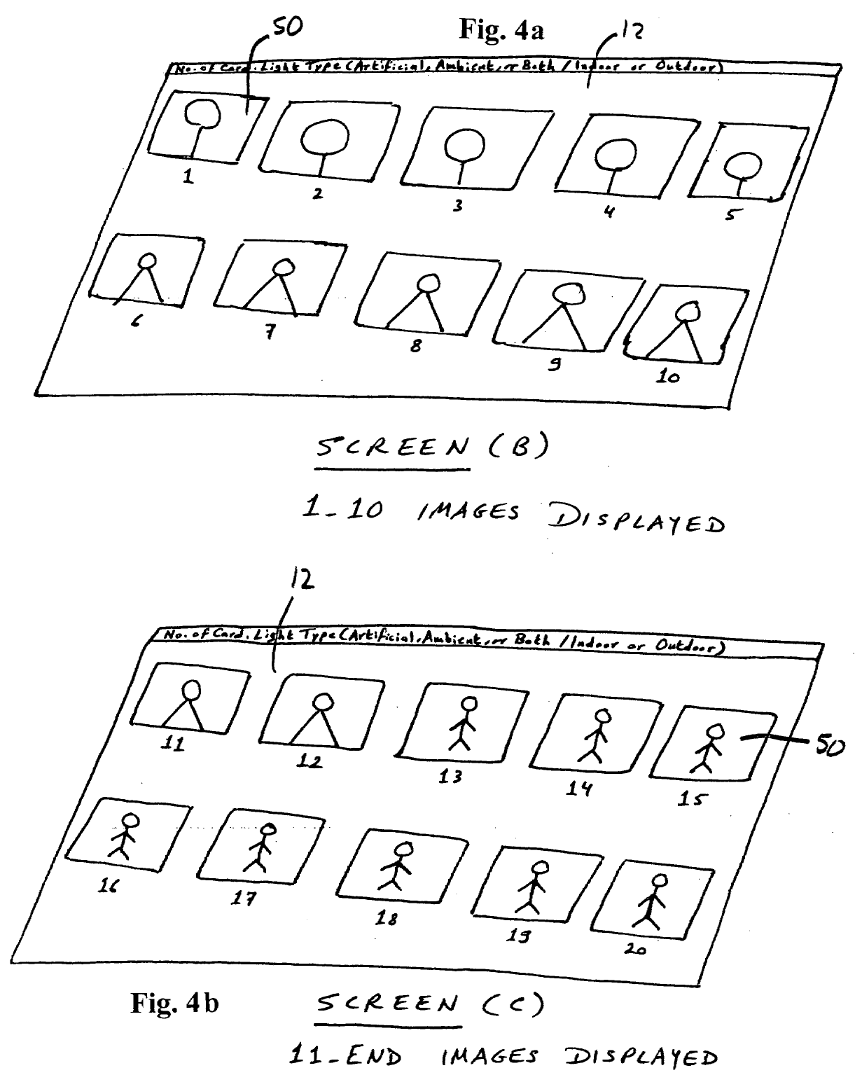

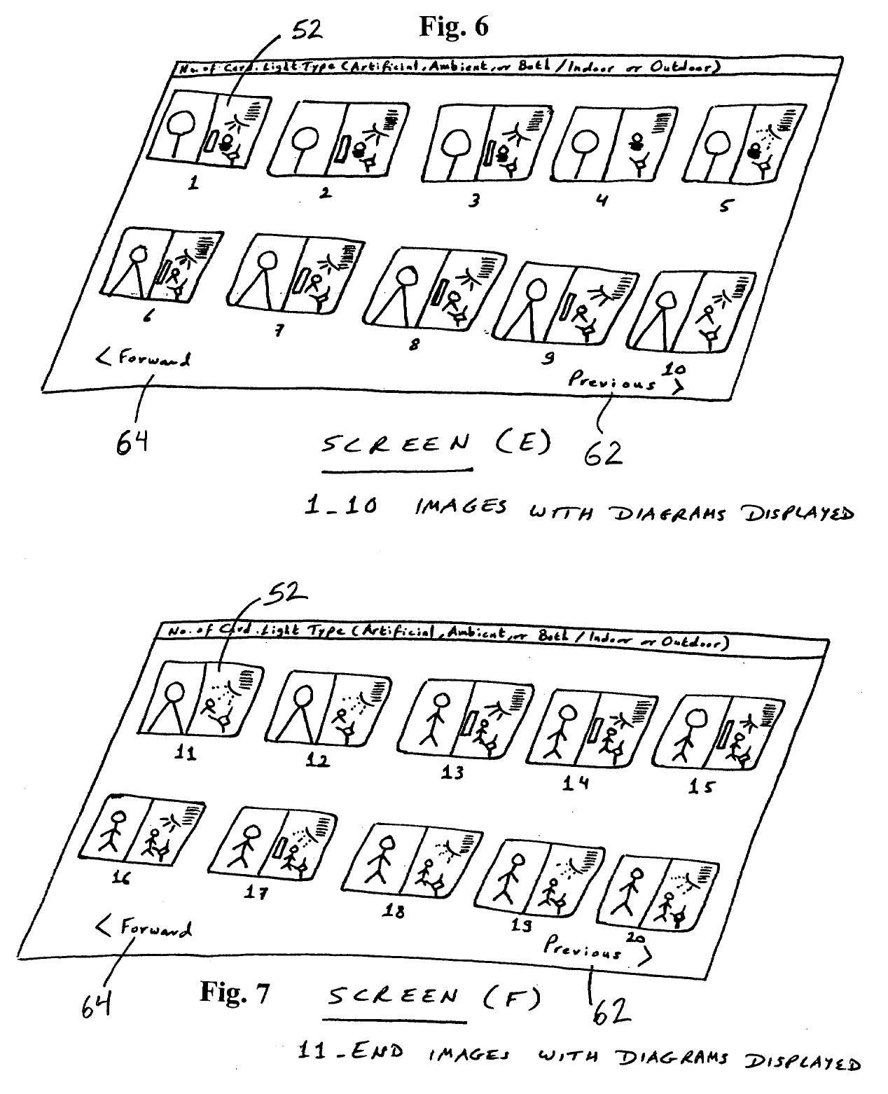

When viewing the diagram 52, such as in FIGS. 6, 7, 8 and 9, the curser 54, as shown in FIG. 3, may be moved to the location of “Previous” 62 or “Forward” 64 on a given screen, such as shown in FIGS. 6, 7, 8, 9 and 10, and, with a click on the Enter Key 24, be used to substitute a previous or forward display with an existent one (so as to move from screen “D” to “E”, “F”, “G”, “H”, and “I”, and vice versa).

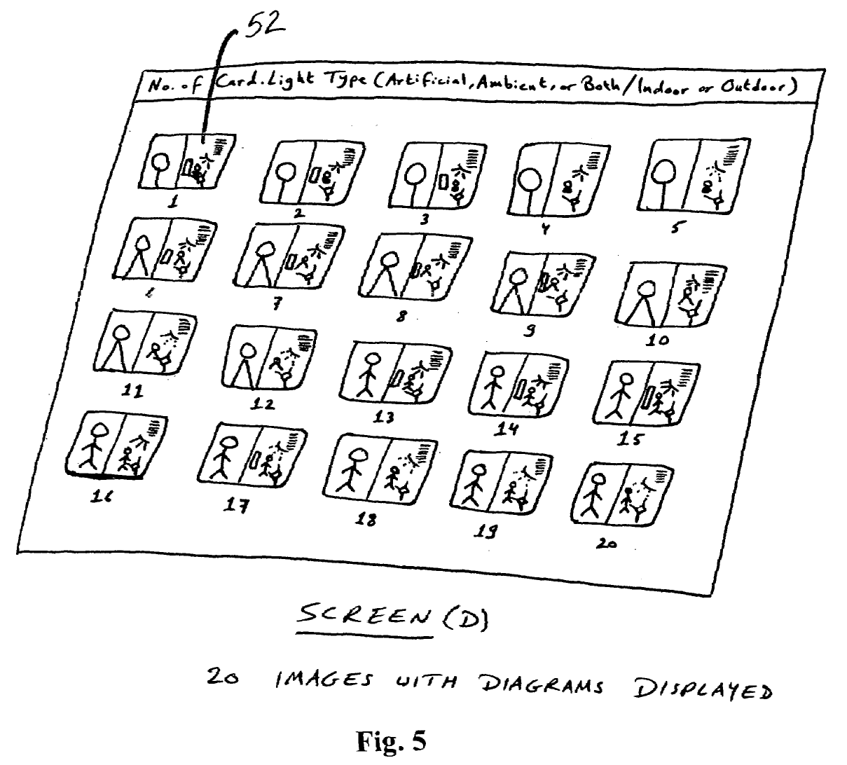

On the left side of the keyboard 14, there is a button called “Images with Diagrams” 36 that, once pressed, displays each and every image (or images) with a diagram 52 (or diagrams) and other relevant information corresponding to each image as shown in FIG. 5.

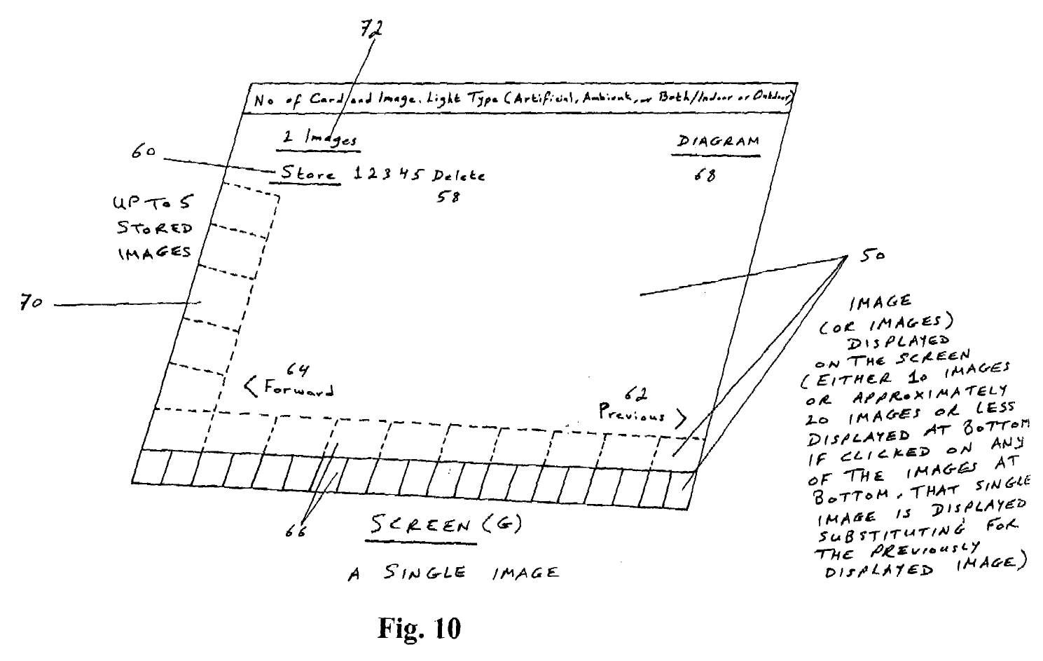

Such diagram(s) 52 may also be obtained in a variety of ways. They may be obtained by moving the curser 54 to Previous 62 and Forward 64 and clicking the Enter Key 24 such as in FIGS. 6, 7, 8, 9 and 10. They may also be obtained by clicking the Enter Key 24 while the curser 54 is placed on “Diagram” 68 on the screen 12. Furthermore, by clicking on the single image screen, FIG. 10, the user may move from the single image 50 to its diagram 52 and other relevant information directly.

Also, on the left side of the keyboard 14 is a button called “Background Information” 32. Once it is pressed, the display 12 displays background information pertaining to the constituent elements used to take the images 50 such as more detailed information about the manufacturers, brands, and types of cameras, lenses, filters, gels, digital card, film, digital or film laboratory processing, reflexes, sun reflection, sun screening, or both, and other pertinent information. This background information may be classified generally for all the images 50 displayed from the memory, or specifically, as numerically indexed, pertaining to each image.

On the left side of the keyboard 14, there is also a button called “Basic Information” 34. Once it is pressed, it displays basic information on a number of subjects, as described in Contents of Images and Diagrams.

There are a few ways of exiting the Background Information screen or Basic Information screen. One way is to simply close the displayed screen; the previously displayed screen (if any) would show instead. Another way is to highlight and click on Previous 62 on the Background Information or the Basic Information screen, and the previous image would show instead. The latter option would allow for returning to the same displayed screen in Background Information or Basic Information if Forward 64 was highlighted and clicked on in the substituting screen.

### Manipulating Images

Once a single image 50 is displayed on the screen, all other images 50 from which that single image was chosen, whether twenty images, ten images, or less, are displayed as much smaller images 66 at the bottom of the single image 50 (as shown in FIG. 10) so as to give the user the option to compare that single image 50 to other images 66 on the same memory. Once any of these smaller images 66 is clicked on, it takes place of the displayed image 50 on the screen.

If two images 50 are desired to be displayed on the same screen, the user could do so by highlighting and clicking on the “2 images” 72 location. The image displayed would be a very small image size on the lower left corner of the screen and would take half of its previous size only after the second chosen image from the twenty image screen, or the ten image screen, or less, at the bottom of the screen is chosen so that it would appear in equal size next to the first image. If no second image is selected, the user can retrieve the full size of the first image by clicking on the small size image on the lower left corner of the screen.

### Store Images

The images can be stored in the memory of the Pro-Standard Screen, regardless of which Pro-Standard card is being used, as exhibited in stored images 70, by pressing “Store” 60. Once Store 60 is highlighted and clicked, the cursor can be moved to the image chosen to be stored, whether the main image or one of the twenty images, ten images, or less, exhibited on the Screen 66. Once that image is clicked on, it is immediately stored in the memory of the digital screen device, as indicated by a digital number next to Store 60, ranging from one to five, as no more than five images can be stored in the digital screen device. In order to retrieve a stored image, the user must move the cursor 54 to the chosen image, as indicated by its corresponding digital number next to Store, and then click on that number. The chosen image would appear on the main screen, carrying the same essential attributes of any other displayed image on the main screen, as shown in FIG. 10. If, for comparison or any other purposes, two images are chosen, the user must highlight and click on the “2 images” location 72, and then click on the two chosen images from the smaller images displayed on the screen, whether from the stored images 70 or images retrieved from the memory card 66 or its equivalent, or click on only one of the smaller images displayed on the screen, next to the main image already existent on the screen. Both chosen images would appear on the screen 12 next to each other, and corresponding diagrams can be drawn so as to explain their characteristics. In order to return either image to memory, the user must highlight and click on Store 60, and by clicking on either one or both images, such images are stored again in memory.

If the user chooses to display one or more of the stored images in a smaller image size on the screen for reference, he could do so by double-clicking on the digital number corresponding to the image chosen to be displayed as such. The chosen image would immediately appear in a small image size on the bottom left side of the screen. If the user chooses a second image to be displayed as such, he could do so by double-clicking on the digital number corresponding to the second image chosen, the image would appear above the previously chosen image, and so on, as shown in FIG. 10. If the user chooses to enlarge the smaller size image on the screen, he could do so by clicking once on the smaller size image chosen on the left side of the screen, and that smaller size image would become the main image on the screen. If the user, however, decides to undisplay the stored image, whether in its small image size or as a main image on the screen, he could do so by double-clicking on that image. The stored image would then disappear from the screen and return to memory in the form of a digital number next to Store. In order to delete an image from the memory of the digital screen device, the user must go to the location of “Delete” 58 next to the last digital number corresponding to the last image stored, and highlight and click on Delete 58. Once the stored image exhibited on the main screen is clicked on, such an image would be deleted from memory.

### Memory Cards

The smart cards, electronic devices, or any other similar memory device used in the digital screen device are numbered and classified according to light type, whether artificial, ambient, or a combination of both, color, camera and lens. As such, displayed on the upper part of each showing on the screen is the number of the card used as well as the light type, color, camera and lens. And when a single image is displayed, the number of the card or its equivalent and the number of the image as well as the light type, color, camera and lens are shown.

The smart card, electronic device, or any other similar medium, that goes into the self-contained computer should not be deciphered or copied by any other means.

The smart card, electronic device, or any other similar media, may have an interesting and totally different shape from any other such similar media, while making sure that no information can be obtained from the smart cards or their equivalent other than in the receiver in the keyboard, and in combination with a receiver and a transmitter in the screen.

All the communication links, or wires, going from and to the smart cards, electronic devices, or any other similar media, and the self-contained computer must be encrypted and screened. Storage or contents of the memory in the self-contained computer must also be encrypted.

The keys stored in the smart cards, electronic devices, or any such similar media, are generated using a diversified key approach.

### Screen

The digital screen device is expected to be built in such a way that surpasses in image quality any other computer. Critical issues for the successful functionality and operation of the digital screen device must be addressed. The quality of the images as exhibited on the screen must be of the highest standards, allowing for maximum predictability in expected results, and most accurate, clear, detailed, and consistent. The fast speed (almost instantaneous) with which the digital screen device is started and images are exhibited and retrieved on the screen must surpass any such speed by any other computing device existent on the market.

The rectangular shape of the digital screen device may likely be built in a different form from that of the regular computer. The idea is to match the shape of the digital screen device to the expected shape of the images exhibited, while allowing for relevant information to be exhibited as well. Therefore, it may retain the regular shape of other computing devices, it may take a square-like form, or somewhere in between, as might be necessary for the proportionate matching of the screen to the images, while allowing for minimum unnecessary background space.

### Conventional Device

On a conventional computing device, the digital screen device offers corresponding controls to the ones on the self-contained computing device. Controls such as the battery indicator, power connectors and so forth are provided by standard computing platforms. Controls to manipulate the images on the Pro-Standard Cards are provided using common User Interface techniques, such as menus, buttons and scroll bars.

On a conventional computing medium, such as a memory card, smart card, disk, CD, DVD, electronic chip, or any other computer data delivery medium as may be produced presently or in the future, the same features in the digital screen device or the conventional computing device exist.

The display of information on the digital screen device or the Pro-Standard Screen can be alternatively provided in any other visual format.

### Published Format

Although the invention has been described in connection with digital memories and computer related components, it is anticipated that all of the information classified, listed and stored in the digital memory can also be transferred into a published format, such as in a book, and the procedures would be carried out in searching the published format for the preferred lighting and color characteristics as such that the user would be looking in the published format for an example photograph and finding the corresponding diagram and other relevant information for the image chosen. Essentially the same method is undertaken with the exception of the data and information not being in an electronic format.

### Protection

The memory of the Pro-Standard Screen must be protected from either deciphering or copying. The digital screen device is built in such a way that its hardware, circuits, wires, or transmitters in the keyboard, the screen, or both, do not allow for the information to be transmitted to and deciphered anywhere else. Maximum security of data in the digital screen device is ensured by sealing all inside ends. A special receiver and transmitter within the semblance of the Screen 12 to decipher information from, and send information to, the keyboard must be installed. Such a special receiver and transmitter, along with a receiver and transmitter in the keyboard, is especially designed and built for the digital screen device, so as to ensure that it is impossible to use or derive any information from the memory card, or the equivalent, to the keyboard and, then, to the screen, and vice versa, in any other medium than the digital screen device.

### Accessories

The Pro-Standard Screen has especially-made leather coating. In the leather coating of the Pro-Standard Screen there would be space for an additional 5 Pro-Standard Cards, or the equivalent, so that the user of the Pro-Standard Screen could readily and easily have access to at least ten images, five stored in memory and at least five available in the Pro-Standard Cards, or the equivalent, such as stored in the leather coating of the Pro-Standard Screen.

The Pro-Standard Screen has also leather coating for one, two, or more, removable and (optional) extra layers or bases of battery 16, each of which would be placed beneath the keyboard 14, and would compliment the normal-size battery beneath the Screen 12 and would allow for many extra hours of usage without connecting to electricity, if so chosen.

1. An apparatus for achieving photographic effects comprising:
a digital display screen; and
digital memory containing multiple example images and diagrams to show how those example images were taken.

2. The apparatus of claim 1 wherein the images in the memory are classified by lighting type.

3. The apparatus of claim 1 wherein the images in the memory are classified by color.

4. The apparatus of claim 1 wherein the images in the memory are classified by camera.

5. The apparatus of claim 1 wherein the images in the memory are classified by lens.

6. The apparatus of claim 1 wherein the images in the memory are displayed along with a diagram showing attributes of how the example image was acquired.

7. The apparatus of claim 1 wherein the images in the memory are displayed along with a list showing the settings used when the example image was acquired.

8. The apparatus of claim 1 wherein the digital memory contains images obtained by a comprehensive study of light and color with varying attributes of the photographic process.

9. A method for achieving photographic effects, comprising the steps of:
choosing a digital memory for the type of lighting the photographer will use, whether ambient, artificial or both;
inserting the memory into a digital display screen;
displaying a number of example digital photographs from the memory;
choosing the photograph from the memory that has the look selected by the user; and
displaying a diagram and other relevant information of the setup for the photograph.

10. The method of claim 9 wherein the photographs are classified by lighting type.

11. The method of claim 9 wherein the photographs are classified by color.

12. The method of claim 9 wherein the photographs are classified by camera.

13. The method of claim 9 wherein the photographs are classified by lens.

14. The method of claim 9 and further comprising the step of displaying the images in the memory along with a diagram showing the attributes of how the example image was taken.

15. The method of claim 9 and further comprising the step of displaying along with the images in the memory a list showing settings used when the example image was taken.

16. The method of claim 9 wherein the digital memory contains images obtained by a comprehensive study of light and color with varying attributes of the photographic process.

17. The method of claim 9 wherein the digital memory could be displayed on a conventional computing device.

18. The method of claim 9 wherein the digital memory could be displayed as a conventional computing medium, such as a memory card, a smart card, a disk, a CD, a DVD, or an electronic chip, or any other computer data delivery medium as may be produced presently or in the future.

19. A digital device for achieving photographic effects, said digital device comprising:
a system bus;
a central processing unit coupled to said system bus;
an input/output device coupled to said system bus, said input/output device configured to provide a user interface; and
a memory unit coupled to said system bus, said memory unit having stored therein a database containing attribute information regarding the setup to achieve desired results in a photograph.

20. The digital device of claim 19 wherein said memory unit is a removable memory unit adapted for use in said digital image device.

21. The digital device of claim 19 wherein said attribute of said image data includes any combination of: sharpness, brightness, contrast, lighting, focal length and color.

22. The digital image device of claim 19 wherein said attribute of said image data includes any combination of: exposure time, shutter speed, f-stop, white balance setting, and focus distance.

23. The digital device of claim 19 wherein the digital memory card could be displayed on a conventional computing device.

24. The digital device of claim 19 wherein the digital memory could be displayed as a conventional computing medium, such as a memory card, a smart card, a disk, a CD, a DVD, or an electronic chip, or any other computer data delivery medium as may be produced presently or in the future.

25. A method for achieving photographic effects using a digital device, said method comprising the steps of:
a) viewing sample image data;
b) recognizing desired photographic attributes from the sample image data;
c) retrieving from a database information corresponding to said attributes; and
d) automatically communicating the attribute information to the user.

26. The method as recited in claim 25 wherein said attribute of said image data includes any combination of: sharpness, brightness, contrast, lighting, focal length and color.

27. The method as recited in claim 25 wherein said attribute of said image data includes any combination of: exposure time, shutter speed, f-stop, white balance setting, and focus distance.

28. The method as recited in claim 25 wherein step b) further comprises the steps of:
retrieving from said database a query corresponding to said attribute;
automatically communicating said query to said user;
reading a user response to said query; and
automatically retrieving from said database attribute information corresponding to said user response.

29. A system for achieving photographic effects comprising:
a database containing multiple example images and diagrams to show how the example images were achieved; and,
a classification of characteristics of the example images to facilitate searching the database for desired photographic effects.
